(19) United States
(12) Patent Application Publication
(10) Pub. No.: US 2023/0399847 A1
(43) Pub. Date: Dec. 14, 2023

(54) Light Weight, Low Stowed Volume, Space Deployable Batten-less Truss

(71) Applicant: L'Garde, Inc., Tustin, CA (US)

(72) Inventors: Gyula Greschik, Boulder, CO (US); Arthur Libornio Palisoc, Irvine, CA (US)

(21) Appl. No.: 18/035,533

(22) PCT Filed: Nov. 17, 2021
(86) PCT No.: PCT/US2021/072477

§ 371 Date: May 5, 2023

Related U.S. Application Data
(60) Provisional application No. 63/114,809, filed on Nov. 17, 2020.

(51) Int. Cl. E04C 3/28; H01Q 15/16; F24S 23/70

(52) U.S. Cl. CPC E04C 3/28; H01Q 15/161; F24S 23/81

(57) ABSTRACT

Systems and methods described herein include collapsible and deployable truss structures defining reduced volumes for compact storage.

### PRIORITY

This application claims priority to U.S. Provisional Patent Application No. 63/114,809, filed Nov. 17, 2020, which is incorporated by reference in its entirety into this application.

### BACKGROUND

A truss is an assembly of members such as beams, connected by nodes, which create a rigid structure. In engineering, a truss is a structure that comprises force members where the members are organized so that the assemblage as a whole behaves as a single object.

FIG. 1A-1C illustrates an exemplary conventional deployable truss system in which the plurality of members are rigid and coupled together at nodes. Conventional truss systems have been patented, such as U.S. Pat. No. 5,680,145, which is incorporated by reference in its entirety herein. As illustrated, such trusses are comprised of nodes 102 in which force members 102 extend outward therefrom. Each node has longeron force members extending longitudinally along the deployed structure to another node, and batten force members that extend transversely across the deployed structure perpendicular to the longeron force members. The force members 102 are rigid and create a single defined rigid structural object. In order to deploy the truss, deployment cables 106 are used. The cables 106 are flexible.

As illustrated, because all of the truss members are coupled together at nodes with multiple or more than two rigid members coming together, the achievable collapsed size of the system is limited by the heights of the rigid structures.

### SUMMARY

Batten-less trusses described herein provide a collapsible structure that reduces the storage volume for deployable structures. Exemplary embodiments may include structures for use as a perimeter truss for reflector antennas and/or solar concentrators.

Exemplary embodiments include a truss comprising an assembly of members such as longerons, connected by nodes, that create a rigid structure when deployed. Exemplary embodiments of the batten-less trusses may include longerons that are collapsible between nodes. The longerons may be hinged, comprise a shape memory composite, or include other deformable material.

### DRAWINGS

FIG. 1A-1C illustrate exemplary prior art truss systems.

FIGS. 2A-2C illustrate an exemplary collapsed to expanded deployment sequence of an exemplary batten-less truss according to embodiments described herein.

FIGS. 3A-3B illustrate an exemplary deployment system for use in the batten-less truss system according to embodiments described herein.

FIG. 4 illustrates an exemplary support structure comprising exemplary embodiments of the batten-less truss according to embodiments described herein.

FIGS. 5A-5B illustrate an exemplary application using the support structure comprising exemplary embodiments of the batten-less truss according to embodiments described herein.

FIG. 6 illustrates an exemplary component exploded view of the application of FIGS. 5A-5B.

FIGS. 7A-8B illustrate an exemplary comparison of the reduced storage volume achievable with exemplary embodiments of the batten-less truss according to embodiments described herein.

### DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Exemplary embodiments may use a deformable member as a support and deployment structure for use within a truss system.

Although embodiments of the invention may be described and illustrated herein in terms of specific support structure, it should be understood that embodiments of this invention are not so limited, but are additionally applicable to different configurations. Exemplary embodiments also disclosed herein include different combinations of the deformable options as a support; any combination of such support structures or alternative deformable options are contemplated for use herein. Exemplary embodiments may include alternative features, such as a tear away surface, removable retraction or stowage material or cords, an envelope, one or more antenna shapes, one or more sleeves or envelopes, one or more support infrastructures, a hub, one or more inflation mechanisms, housings, actuation devices, controllers, cables, pulleys, etc. Any feature, component, configuration, and/or attribute described for any one example may be used in combination with any other example. Accordingly, any step, feature, component, configuration, and/or attribute may be used in any combination and remain within the scope of the instant description. Features may be removed, added, duplicated, integrated, subdivided, or otherwise recombined and remain within the scope of the instant disclosure. The exemplary embodiments described herein are provided for sake of example only. Therefore, any antenna, collector, support structure, or other configuration may be used with or without any of the components described herein.

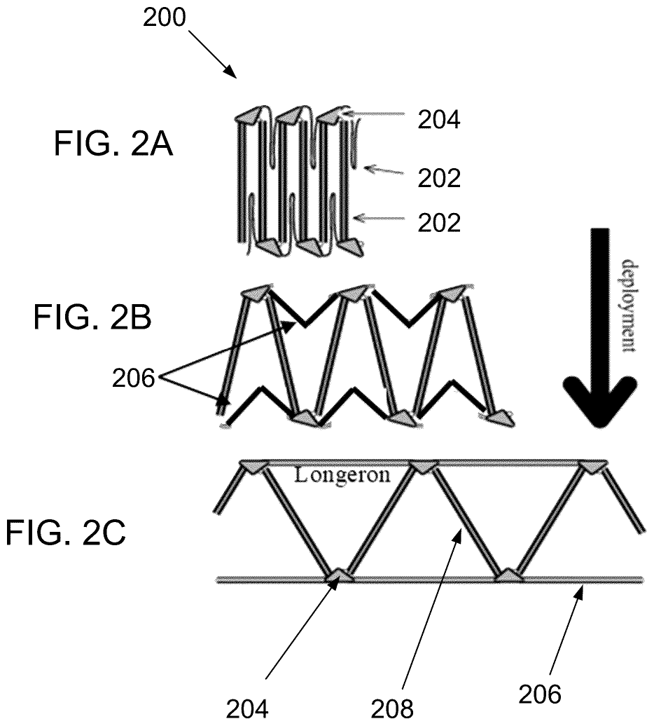

FIGS. 2A-2C illustrate an exemplary collapsed to expanded deployment sequence of an exemplary batten-less truss according to embodiments described herein. FIG. 2A illustrates an exemplary configuration in which the longerons are fully folded. Diagonals are illustrated in a vertical orientation. The illustrated diagonals in this example are not telescoping. FIG. 2B illustrates an exemplary configuration in which the longerons are partially folded. FIG. 2C illustrates an exemplary configuration in which the section of the truss is fully-deployed. The truss is configured as a Warren Truss.

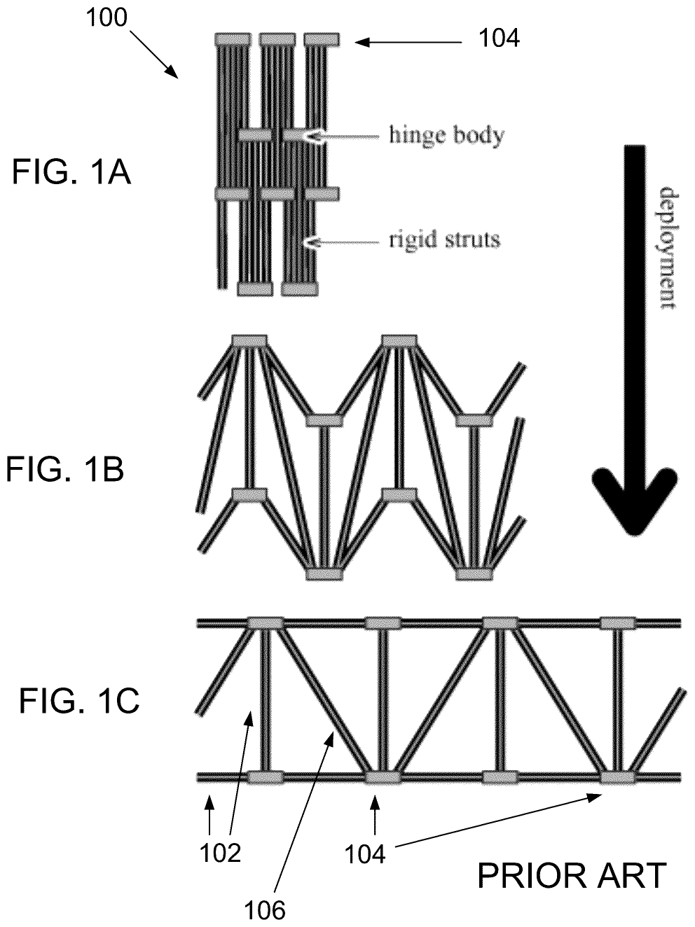

FIG. 2A shows how the batten-less perimeter truss is stowed in an exemplary configuration. As illustrated, the height of the folded/stowed configuration can be approximately the length of a diagonal member. The stowed height can be made shorter by using telescoping diagonals. The FIG. 2A configuration can be compared with the stowage height of the exemplary prior art systems of FIG. 1A. The difference in stowage height is shown more clearly in FIGS. 8A to 8B.

The exemplary truss 200 is configured from structural members 202 coupled by nodes 204. The structural members may comprise diagonals 208 and longerons 206. The longerons are configured to extend longitudinally along a length of the truss in a deployed configuration according to embodiments described herein. The diagonals are configured to extend across and along the truss in a deployed configuration, or at an angle with respect to the longerons in the deployed configuration according to embodiments described herein. The diagonal of the truss is configured such that it is not perpendicular to the longerons in a deployed configuration.

In an exemplary embodiment, the diagonal members may be rigid members that are not configured to substantially deform during storage or deployment. The longerons may comprise deformable members that are configured to deform or have a different shape from the storage configuration to the deployed configuration. As used herein, a deformable member may comprise any configuration that deforms as described herein. For example, the deformable member may be flexible such that it flexes under the application of an outside force.

The terms rigid and flexible are used herein and are understood to be relative terms. Therefore, although it is understood that a rigid structure may still have some flexing under the application of a sufficient outside force, such absolute rigidity is not required. Instead, it will be understood by a person of skill in the art that the rigid structure is intended to generally maintain its shape during normal operation and for the intended purpose. The flexible structure is considered one that deforms along a length. The deformation may be through the application of a sufficient outside force without separating or breaking the structure so that it can be repositioned back into an original form. The deformable structure is considered one that deforms at a point or along a length. The deformable structure may therefore comprise joints, hinges, living hinges, flexible members, or a combination thereof.

Exemplary embodiments described herein comprise deformable structures that may still provide structural rigidity when the structure is fully deployed. For example, the deformable structure may be configured to deform under an application of a transverse or sheer force applied to the structure. The transverse force may be applied through the system architecture in order to deform the deformable structure and position the structure in a stowed configuration. The deformable structure may be configured to maintain its shape or remain rigid under the application of a compression or longitudinal force applied to the structure. The rigidity of the structure may be maintained in the normal use of the structure in its deployed configuration. The deformable structure may therefore comprise both deformable and rigid qualities depending on the direction of the applied forces.

Exemplary embodiments of the deformable structure may comprise any combination of configurations to achieve the deformable configuration described herein.

For example, exemplary embodiments of the deformable structure may comprise shape memory composites. These composites may be flexible and permit dynamic deformation under an application of an external force. The shape memory composite may also be frozen or retained in the deformed configuration, such as through a temperature transition. The shape memory composite may be configured to return to a remembered configuration. The remembered configuration may be through a passive or active transition. The shape memory composite may passively return to a remembered configuration for use in a deployed configuration by returning to a remembered configuration after the external force causing the deformation is removed. The shape memory composite may actively return to a remembered configuration when a transition condition is met, such as a change in a temperature or an application of an electrical current.

Exemplary embodiments of the deformable structures described herein may comprise elastomeric shape-memory carbon composite material. Exemplary embodiments may include other high-strain materials. Exemplary embodiments of the shape memory composite material may be used as structural elements such as the longeron members of the truss as described herein. The longerons may include structural fibers impregnated with elastomeric resin or a shape memory metal, e.g. Nitinol. The structural fiber may be made of carbon, fiberglass, aramid (e.g. Kevlar), Vectran, or combinations thereof. The longerons may be wrapped with a very thin piece of a membrane coated with SiO2 and/or Al2O3 for protection against atomic oxygen. The coatings may comprise about 50 Å of SiO2 or 35 Å of Al2O3. These coatings at these thicknesses have been shown to protect against degradation by atomic oxygen that are present at lower LEO altitudes.

Exemplary embodiments of the deformable structures described herein may comprise a thermally-stable, shape-trainable, high-strain super elastic shape memory alloy material. Exemplary embodiments of the shape memory alloy material could be made of Nitinol or other alloys of Ni—Ti composite. Exemplary embodiments may include ternary alloy types of Ni—Ti that adds a third element for the purpose of making a more stable performance in shape setting, shape accuracy, and longevity in the space environment. The properties of the shape memory composite alloy can be tuned by controlling the relative amounts of alloy elements.

Exemplary embodiments of the deformable structures described herein may include rigid members comprising flexible or deformable sections. For example, the deformable structure may comprise rigid members coupled by a hinge. Exemplary hinges may be creased by sockets, rods, flexible material, or other known hinge structures.

The deformation may be dynamic or structured. The dynamic deformation may permit deformation based on the applied force to deform the structure. The dynamic deformation may permit deformation of the member along a length of the member in response to the applied force. The member may therefore deform into different shapes or configurations under different applied forces. The structured deformation may permit deformation in a known or pre-determined way. An example of a structured deformation is a hinge.

As illustrated in FIG. 2B to 2C, exemplary embodiments of the truss structure described herein comprises a plurality of structure members coupled together by a plurality of nodes. The connection between the structural member to the node permits the structural members connected at the node to be repositioned relative to each other to transition between a deployed configuration to a stowed configuration, and vice versa. As illustrated each node comprises at least two structural members—at least one diagonal structural member and at least one longeron structural member. Interior nodes may comprise at least four structural members—at least two diagonal members and at least two longeron members coupled to the same node. Therefore, a plurality of nodes may comprise at least four structural members extending therefrom.

In an exemplary embodiment, the diagonal structural members are rigid. The diagonal structural members may be rigid in the deployed configuration, stowed configuration, and transitions between the stowed and deployed configurations.

In an exemplary embodiment, the longeron structural members are deformable. The longerons structural members may be deformable according to any configuration or embodiment described herein. The longeron structural members may be deformable in a transition from the stowed and deployed configuration as described herein. The longeron structural members may be rigid in the deployed configuration under expected and/or normal operating forces, such as compression forces applied to the longerons.

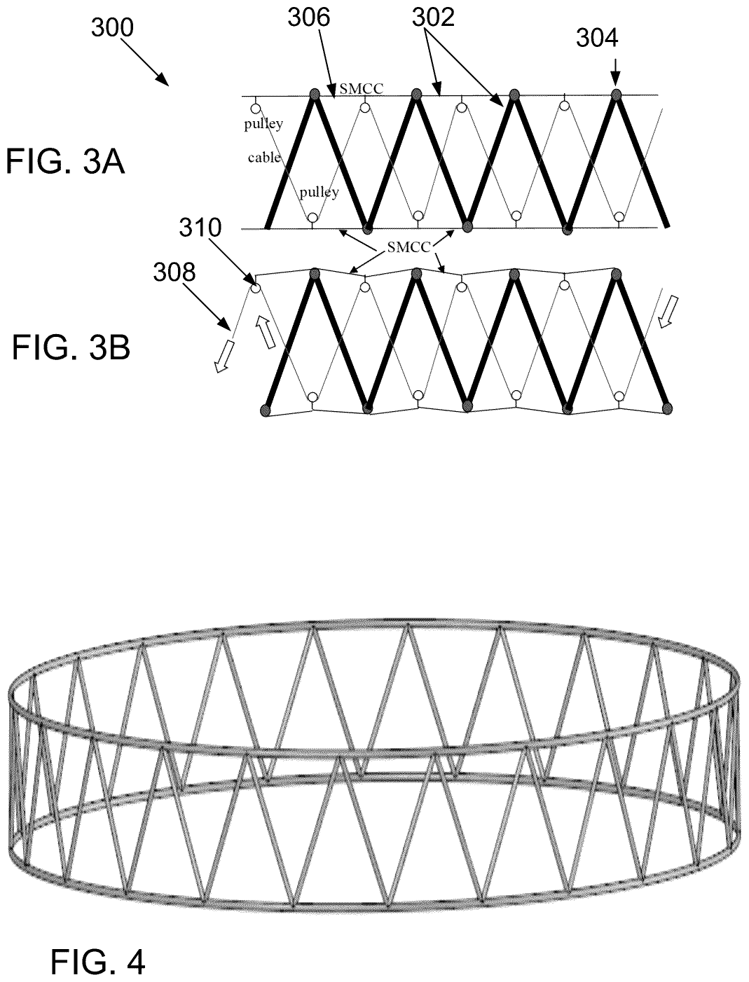

FIGS. 3A-3B illustrate an exemplary deployment system for use in the batten-less truss system according to embodiments described herein. FIGS. 3A-3B illustrates an exemplary structure in the shape of a Pantograph Truss.

Exemplary embodiments described herein may comprise a deployment system that may assist in the transition of the truss from a collapsed configuration to a deployed configuration or from the deployed configuration to a collapsed configuration.

An exemplary embodiments of a truss structure 300 comprises a plurality of structural members 302 and nodes 304. The structural members and nodes may comprise the structural members 202 or nodes 204 as described with respect to FIGS. 2A-2C or as described herein. The structural members 302 may comprise a deformable structure as described herein. The longeron as illustrated may be the deformable.

As illustrated, the longeron comprises a deformable member comprising a shape memory composite. The shape memory composite may be deformable under an application of an outside force. The shape memory composite may have a remembered configuration that it automatically or passively returns to after the outside force is removed. As illustrated, the remembered configuration is the linear configuration and the deformed configuration is bent.

The truss system 300 illustrated herein also provides a deployment system. The deployment system may comprise a cable 308 and a plurality of pulleys 310.

The system may comprise a deployed configuration as illustrated in FIG. 3A. The cable may be positioned such that a neutral tension is applied to the cable, or in which the cable is not under tension so that the cable does not impose a sheer force on the longerons. Since the cable is not applying an outside force on the longerons, the longerons maintain their remembered configuration. The longerons are therefore straight and deployed.

The system comprises a stowed configuration in which the longerons are deformed and the structure is collapsed. FIG. 3B illustrates an exemplary transition from the deployed configuration toward the stowed configuration. A force is applied to the cable 308, putting the cable in tension. The cable is coupled to opposing sides of the truss and zig-zags between adjacent longitudinal longerons on the same side of the truss and opposing longerons on opposite sides of the truss. For example, the cable is coupled to a first longeron on a first side of the truss, then to a first opposite longeron on a second side of the truss. The second side of the truss is opposite the first side of the truss. The first longeron may be longitudinally offset from the first opposite longeron. The cable may then be coupled to a second longeron on the first side of the truss. The second longeron may be longitudinally adjacent to the first longeron. The second longeron may be longitudinally offset from the first opposite longeron. The cable may then be coupled to a second opposite longeron. The second opposite longerson may be longitudinally adjacent to the first opposite longeron, and may be longitudinally offset from the second longeron. The cable may repeat n longerons and n opposite longerons in this manner creating a zig-zag between opposite sides of the truss. As a force is applied to the cable, a force is imposed on the deformable longeron members deforming the members toward a center of the truss or toward the opposite side of the truss. The system may therefore be configured to collapse and may stay in the stowed configuration by the continued application of tension on the cable. Once the tension is removed from the cable, the longerons may return to a remembered configuration and deploy to the deployed configuration.

FIG. 4 illustrates an exemplary support structure comprising exemplary embodiments of the batten-less truss according to embodiments described herein. FIG. 4 illustrates an exemplary structure in the shape of a Warren Perimeter Truss.

Exemplary embodiments described herein may be used as a design for a low weight, low stowed volume space deployable perimeter truss for antennas and concentrators. Exemplary embodiments described herein may comprise longerons and diagonals. In an exemplary embodiment, there are no transverse or batten members. Exemplary embodiments comprise any combination of configurations as described herein.

In an exemplary embodiment, the longerons and the diagonals can be made of rigid members such as steel, aluminum, or titanium. They can also or alternatively be made of composites of (a) carbon, (b) fiberglass, (b) Kevlar, (c) Vectran, (d) elastomeric shape memory carbon composite (SMCC), (e) rigidizable composite material made of Sub-T_{g} resin-impregnated structural fabric, (f) similar material, or (g) combinations thereof. The structural fabric for a Sub-T_{g} composite may be (a) carbon, (b) fiber glass, (c) Kevlar, (d) Vectran (e) similar material, or (f) combinations thereof.

When the members are made of shape memory composite (SMCC) structural fabric, the resulting composite can be folded for packaging and when the restraint is removed, it deploys and seeks its memorized shape. When the longerons on the other hand are made of rigid members like steel, aluminum, titanium, composites of (a) carbon, (b) fiberglass, (c) Kevlar and (d) Vectran, there may be a locking hinge at its midpoint or along its length. The hinge may be used to bend the longeron at its midpoint or other desired length for stowing. When a SMCC composite material is used, a hinge is not necessary since the material is pliant when a point load is applied normal to its length—the longeron can be bent at its midpoint or desired location. When the SMCC member is deployed, it can become a compression-tension member.

A Sub-T_{g} resin as describe herein may be a polymeric or polyurethane resin that becomes rigid when its temperature goes below its glass-transition temperature, T_{g}.

The shape memory composite material permits exemplary embodiments described herein to collapse under imposition of an outside force in a non-structured fashion. The collapsed configuration may therefore be dynamically determined based on the storage compartment or the outside force applied. For example, the shape memory composite may be flexible or deformable along a length when a force is applied. The shape memory composite, however, returns to a remembered configuration, once the force is removed. Therefore, exemplary embodiments may include a stored configuration in which the de-orbit device structure is retained in the stored configuration having a reduced storage volume through application of an outside force; and a deployed configuration in which the de-oribt device structure is fully deployed having a larger storage volume when the outside force is removed. In other words, the remembered or biased configuration may be a deployed configuration in which the de-orbit device structure is configured for use as a solar sail or atmospheric de-accelerator, or other large area shape. In an exemplary embodiment, the shape memory composite may flex in any direction under application of an outside force. In an exemplary embodiment, the shape memory composite may flex at multiple locations along a length of the member or along an entire length of the member. In an exemplary embodiment, the shape memory composite may return to a remembered configuration, such as linear, circular, ovoid, curved, parabolic, helical, spiral, or other predefined shape when the outside force is removed.

An exemplary shape memory composite material includes a base material of one or more of carbon fiber, Vectran, Kevlar, fiberglass, glass fibers, plastics, and/or fiber metal. The base material comprises strands. The strands may be generally aligned along a length of the structure, may include one or more aligned arrangements, may be wound or helically positioned, may be woven, or any combination thereof. The shape memory composite material includes a matrix around and/or between the base material. The matrix may be silicone, urethane, or epoxy. Exemplary shape memory composite materials are described in co-owned patent application U.S. Patent Publication Number 2016/0288453, titled “Composite Material”. High strain material to permit deformation. High strain material generally has capability to strain beyond 3% and not enter the plastic deformation. In other words, the material may yield beyond 3%.

In an exemplary embodiment, the shape memory composite material has a volume fraction ratio of fiber-to-resin that may be controlled to achieve a desired shape memory retention even after long-term stowage in a folded/packaged state. An exemplary fiber-to-resin volume fraction ratio is from 52 to 65, namely 52% to 65% fiber or 48% to 35% matrix or resin. The average fiber-to-matrix ratio is about 58%. The fibers may be carbon, Kevlar, Vectran, nylon, or otherwise described herein and the resin may be urethane, silicone, or epoxy or otherwise described herein as the matrix.

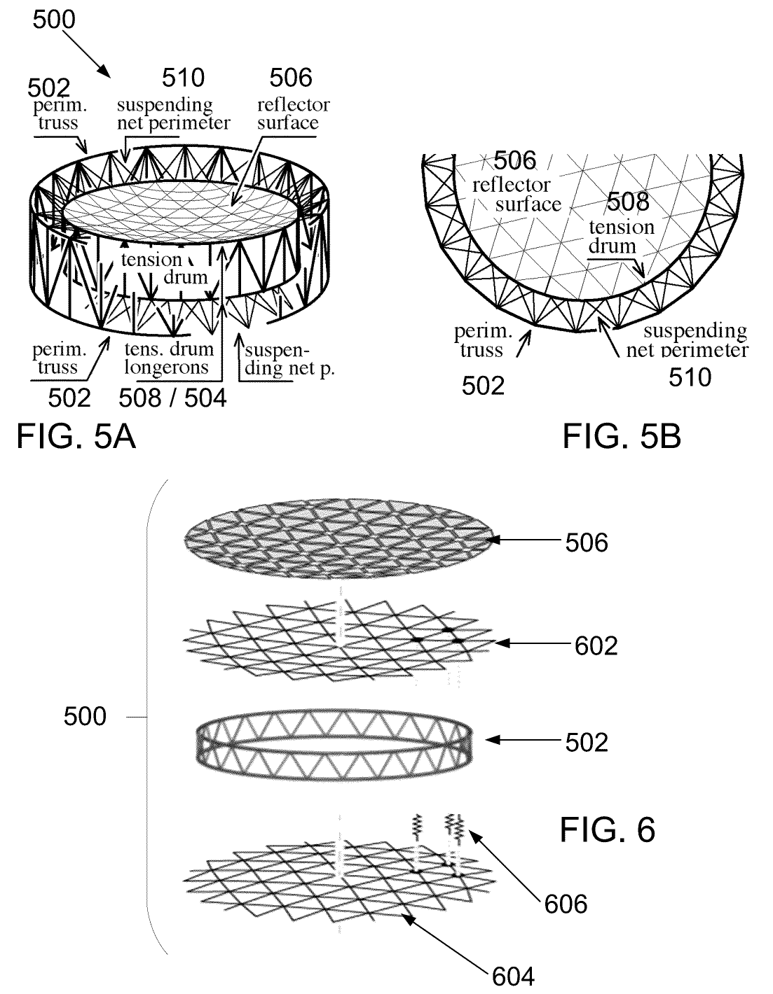

FIGS. 5A-5B illustrate an exemplary application using the support structure comprising exemplary embodiments of the batten-less truss according to embodiments described herein. FIG. 6 illustrates an exemplary component exploded view of the application of FIGS. 5A-5B. The application of FIGS. 5A-6 illustrate an exemplary concept of a batten-less (no verticals) space deployable antenna. Other applications are also contemplated herein, such as reflectors, collectors, etc.

Large area reflectors in space are typically used as radio-frequency (RF) reflector antennas for communications or radar imaging, as well as for solar concentrators to produce photovoltaic power. A space deployable reflector antenna or solar concentrator is preferably lightweight, and can be collapsible into a volume small enough to fit within the fairing of a rocket booster. Exemplary embodiments described herein include a low-weight, low-stowed-volume collapsible reflector antenna/concentrator perimeter truss support without battens (transverse members). An exemplary purpose of the perimeter truss in this embodiment is to connect and support the reflector and invert domes. The reflector and invert domes that may be mated with the perimeter truss are net mesh surfaces made of stiff non-conducting or conducting material. The reflector dome may be designed, such that under the proper tension, it achieves a certain shape—a surface of revolution. The surface of revolution may be any surface of revolution; e.g., a paraboloid surface, spherical surface, etc., or substantial approximations thereto. The invert dome may be a mirror image of the reflector dome but does not have to be as accurately a mirror image of the reflector dome. Between the invert dome and the reflector dome are tension ties (force elements) used to impart stress or tension to the conducting mesh. Thus, the reflector and invert domes provide the anchor points for these tension ties. When properly tensioned, the reflector dome contacts the conducting mesh and forces the conducting mesh to take the same shape as the reflector dome. The conducting mesh serves as the reflector of electromagnetic energy. For RF applications, the conducting mesh may also be a thin film metalized with a few hundred Angstroms of vapor-deposited or sputtered aluminum or silver. For a solar concentrator application, the conducting mesh is replaced by a thin film metalized with a few hundred Angstroms of vapor-deposited or sputtered aluminum or silver. Thin films of other materials are also possible. The thin film may be a polyimide or a polyester material, for example.

As illustrated in FIGS. 5A-6, exemplary embodiments of a reflector 500 is provided. The reflector comprises a perimeter truss according to embodiments described herein. The perimeter truss comprises longerons 504 as described herein. A reflective surface 506 is coupled to the perimeter truss 502. The support connections suspend the net perimeter 510 and provide tension on an outer edge 508 of the reflector surface creating a tension drum 508. The perimeter truss 502 in this embodiment may couple to and support the reflector dome 602 and invert dome 604. The reflector dome 602 and invert dome 604 may comprise nets, mesh, cables, etc. Between the invert dome 604 and the reflector dome 602 may be tension ties 606 (force elements) used to impart stress or tension to the conducting mesh.

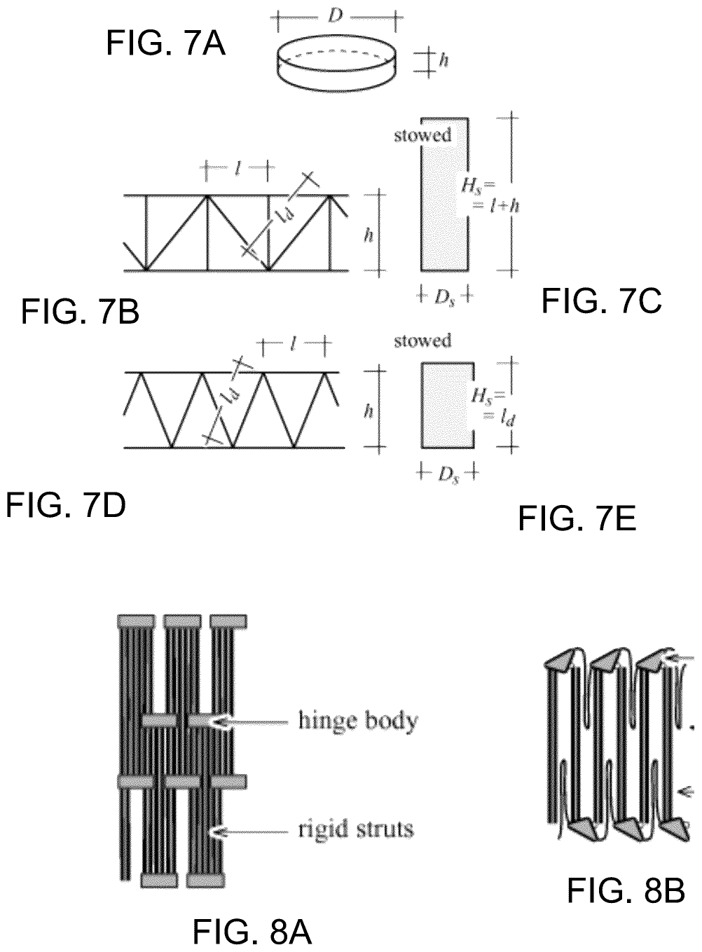

FIGS. 7A-8B illustrate an exemplary comparison of the reduced storage volume achievable with exemplary embodiments of the batten-less truss according to embodiments described herein. FIGS. 7A-8B illustrate the stowed height comparison of exemplary embodiments of the batten-less truss described herein and conventional truss systems.

An advantage/feature of an exemplary embodiment, is that the stowage volume of the exemplary space deployable antenna can be at least one-half that of existing similar configurations. Further reduction in the stowage volume may be achieved by using telescoping diagonals.

As a comparison between FIGS. 8A and 8B shows, the stowed height Hₛ of the configuration of conventional systems is longer than that of the Batten-less truss, I_{d}, according to embodiments described herein, illustrated in FIG. 8B. In FIG. 8B, the batten-less diagonals have not been contracted in the stowed configuration, as could be accomplished if they were made to telescope shorter. Hence, the Batten-less perimeter truss can achieve a stowage height significantly shorter than that of conventional systems.

When the members are made of an elastomeric shape memory composite material, a hinge is not necessary since the material can be folded at the midpoint or desired location similar to folding a Sub-T_{g} material when the Sub-T_{g} is above its glass-transition temperature.

Exemplary embodiments of a design can be implemented with various versions of rigid or rigidizable materials, as discussed above. An exemplary embodiment of this invention utilizes rigid diagonals made of low CTE carbon composite tubes, Shape Memory Carbon Composite (SMCC) for the longerons, gold-plated molybdenum wire for the conducting mesh, and Vectran fabric composite for the reflector and invert domes.

The advantage of this invention over similar deployable space antennas is the fact that the stowage height is shorter, at least half that of the conventional configurations such as that described by U.S. Pat. No. 5,680,145. The implication of this fact is that exemplary embodiments of the batten-less truss could be launched using a rocket booster one size level down from that required to launch the conventional configuration. This translates to tens of millions of dollars of savings in launch cost alone.

The diagonals of the exemplary embodiments described herein can be telescoping diagonals so that the truss can be stowed with a height shorter than its fully-deployed configuration.

In an exemplary embodiment the shape memory component may comprise a shape memory composite. The shape memory composite may comprise fibers retained in a matrix or resin. In an exemplary embodiment, the shape memory composite may flex at multiple locations along a length of the member or along an entire length of the member. In an exemplary embodiment, the shape memory composite may return to a remembered configuration, such as linear, circular, ovoid, curved, parabolic, helical, spiral, or other predefined shape when the outside force is removed. The predefined shape may be the shape of the structure that is maintained without the use of an outside force. The predefined shape may be defined through the relationship and connections with one or more other shape memory composite materials, envelopes, and/or other support structures as described herein.

An exemplary shape memory composite material includes a base material of one or more of carbon fiber, Vectran, Kevlar, fiberglass, glass fibers, plastics, and/or fiber metal. The base material may comprise strands. The stands may be generally aligned along a length of the structure, may include one or more aligned arrangements, may be wound or helically positioned, may be woven, or any combination thereof. The shape memory composite material may include a matrix around and/or between the base material. The matrix may be silicone, urethane, or epoxy. Exemplary shape memory composite materials are described in co-owned patent application U.S. Patent Publication No. 2016/0288453, titled “Composite Material”. Exemplary embodiments include a high strain material to permit deformation. High strain materials generally have the capability to strain beyond 3% and not enter plastic deformation. In other words, the material may yield beyond 3%.

In an exemplary embodiment, the shape memory composite material includes a volume fraction ratio of fiber-to resin that may be controlled to achieve a desired shape memory retention even after long-term storage in a folded/packaged state. An exemplary fiber-to-resin volume fraction ratio is from 52 to 65, namely 52% to 65% fiber or 48% to 35% matrix or resin. The average fiber-to-matrix ratio is about 58%. The fibers may be carbon, Kevlar, Vectran, nylon, or otherwise described herein and the resin may be urethane, silicone, or epoxy or otherwise described herein as the matrix.

In an exemplary embodiment, the member composed of the shape memory composite material may be conductive. All of a portion of the component may be conductive. The component may be conductive by incorporating a conductive material into the shape memory material. The component material may include a metallic powder, coating, wrapping, sheet, film, paint, strands, or combinations thereof. The conductive material may be in the fiber, resin, on the surface of the fiber, on the surface of the component material, or a combination thereof. In an exemplary embodiment, the shape memory composite component is conductive to create the antenna shape by wrapping the component in a thin sheet of copper. The copper sheet may be adhered or otherwise coupled to an exterior surface of the shape memory composite material shaft.

The embodiments described herein may comprise a support structure. The support structure may be collapsible and/or deformable. The support structure may be a dielectric membrane. The support structure may comprise deformable members. The support structure may be an elongated members, rods, fabric, mesh (nets), sheets, and combinations thereof. An exemplary embodiment comprises the support structure used as an antenna, collector, reflector, or other application. The support structure may be coupled to the shape memory composite material, the conductive components, other components of the antenna, or combinations thereof.

In an exemplary embodiment, additional structures may be used to deform and/or support the support structure and/or the conductive component. In an exemplary embodiment, additional structures may include flexible components, but may or may not also be shape memory. Additional support structures may couple to the shape memory components and/or the support structure to couple components parts together, define a deployed shape, support or create additional attachment points between component parts, influence deployment, or otherwise contribute to the design of the antenna structure.

Exemplary embodiments described herein may use any combination of the features described herein. In an exemplary embodiment, support structure and its applications such as for a reflector, antenna, collector, etc., may include any combination of the support structure, shape memory composite components, conductive components, additional structures, whether separate component parts and/or integrated in one or more ways such that a single component part functions as more than one component part. Exemplary embodiments include any combination of the support structure, shape memory composite components, conductive components, and additional structures comprise flexible components. Flexible components comprise a component part that may bend at any point or along a length. In an exemplary embodiment, any combination of the support structure, shape memory composite components, conductive components, and additional structures permit non-structured dynamic deformation. As described herein, the non-structure dynamic deformation permits flexing that may be defined by the external force deforming the component and not in a pre-configured or structurally limited fashion.

Exemplary embodiments described herein comprises a truss structure, including a plurality of nodes, and a plurality of structural members coupled by the plurality of nodes. The plurality of structural members may comprise a plurality of longerons and a plurality of diagonals. The plurality of longerons may comprise deformable members. The plurality of diagonals may comprise rigid members.

Exemplary embodiments described herein may include a system having the truss structure as described herein configured as a perimeter truss; a first support structure coupled to the perimeter truss; a reflective surface supported by the first support structure; a second support structure coupled to the perimeter truss; and force elements connected between the first support structure and the second support structure. The system may comprise a deployed configuration and a stowed configuration. The system in the stowed configuration may include the plurality of longerons to be in a deformed condition. The deployed configuration may comprise the plurality of longerons to be in a remembered condition. The plurality of longerons may comprise a shape memory composite material.

Exemplary embodiments of the system may include a deployment system comprising one or more cables and a plurality of pulleys. The deployment system may be configured such that an application of tension on the one or more cables imposes a force on the plurality of longerons thereby transitioning or retaining the system in the stowed configuration.

The plurality of diagonals may comprise telescoping members. The plurality of lonerons may comprise a shape memory composite material.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Conditional language used herein, such as, among others, “can,” “could,” “might,” “may,” “e.g.,” and the like, unless specifically stated otherwise, or otherwise understood within the context as used, is generally intended to convey that certain embodiments include certain features, elements and/or states. However, such language also includes embodiments in which the feature, element or state is not present as well. Thus, such conditional language is not generally intended to imply that features, elements and/or states are in any way required for one or more embodiments or that one or more embodiments necessarily exclude components not described by another embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item.

As used herein, the terms “about,” “substantially,” or “approximately” for any numerical values, ranges, shapes, distances, relative relationships, etc. indicate a suitable dimensional tolerance that allows the part or collection of components to function for its intended purpose as described herein. Numerical ranges may also be provided herein. Unless otherwise indicated, each range is intended to include the endpoints, and any quantity within the provided range. Therefore, a range of 2-4, includes 2, 3, 4, and any subdivision between 2 and 4, such as 2.1, 2.01, and 2.001. The range also encompasses any combination of ranges, such that 2-4 includes 2-3 and 3-4.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. Specifically, exemplary components are described herein. Any combination of these components may be used in any combination. For example, any component, feature, step or part may be integrated, separated, sub-divided, removed, duplicated, added, or used in any combination and remain within the scope of the present disclosure. Embodiments are exemplary only, and provide an illustrative combination of features, but are not limited thereto.

The invention claimed is:

1. An truss structure, comprising:
a plurality of nodes;
a plurality of structural members coupled by the plurality of nodes.

2. The truss structure of claim 1, wherein the plurality of structural members comprises a plurality of longerons and a plurality of diagonals and the plurality of longerons comprises deformable members.

3. The truss structure of claim 2, wherein the plurality of diagonals comprises rigid members.

4. A system comprising:
the truss structure of claim 3 configured as a perimeter truss;
a first support structure coupled to the perimeter truss;
a reflective surface supported by the first support structure;
a second support structure coupled to the perimeter truss;
and force elements connected between the first support structure and the second support structure.

5. The system of claim 4, wherein the system comprises a deployed configuration and a stowed configuration, the system in the stowed configuration comprises the plurality of longerons to be in a deformed condition.

6. The system of claim 5, wherein the deployed configuration comprises the longerons to be in a remembered condition.

7. The system of claim 6, wherein the longerons comprises a shape memory composite material.

8. The system of claim 7, further comprising a deployment system comprising one or more cables and a plurality of pulleys.

9. The system of claim 8, wherein the deployment system is configured such that an application of tension on the one or more cables imposes a force on the plurality of longerons thereby transitioning or retaining the system in the stowed configuration.

10. The truss structure of claim 2, wherein the plurality of diagonals comprises telescoping members.
